(19) United States
(12) Patent Application Publication
(10) Pub. No.: US 2008/0080920 A1
(43) Pub. Date: Apr. 3, 2008

(54) PRINTER AND METHOD OF CONTROLLING PRINTER

(75) Inventors: Takuya YASUE, Matsumoto-shi (JP); Jun FUKASAWA, Hata-machi (JP)

Correspondence Address: SUGHRUE-265550, 2100 PENNSYLVANIA AVE. NW, WASHINGTON, DC, 20037-3213, US

(73) Assignee: Seiko Epson Corporation, Tokyo (JP)

(21) Appl. No.: 11/863,767

(22) Filed: Sep. 28, 2007

(30) Foreign Application Priority Data
Sep. 29, 2006 (JP) 2006-267608

(51) Int. Cl. B41J 11/04

(52) U.S. Cl. 400/582

(57) ABSTRACT

A method of controlling a printer including a feeder on which plural printing mediums are set, a first roller operable to pickup the plural printing mediums one by one from the feeder, and a second roller operable to transport the plural printing mediums together with the first roller, the plural printing mediums include at least one first medium and a second medium subsequent to the first medium includes: controlling the first and second rollers so that a peripheral speed of the first roller and a peripheral speed of the second roller are equal to each other; and controlling the feeder so that the first roller cannot pickup the second medium from the feeder when receiving the printing instruction for performing the printing operation to only the first medium.

### BACKGROUND

1. Technical Field

The present invention relates to a printer and a method of controlling a printer.

2. Related Art

As inkjet printers for performing a printing operation on a printing medium such as a printing sheet, there is a related printer having a feed roller that feeds a printing sheet into the printer and a paper transport roller that transports the printing sheet at the time of performing a printing operation on the printing sheet fed into the printer (for example, see JP-A-2003-72964 and JP-A-2006-117385).

In the printer described in JP-A-2003-72964, the feed roller is connected to a transport motor rotationally driving the paper transport roller through a clutch and is detachable from the transport motor. In the printer, the printing sheet set in a feed hopper is first transported to a position of the paper transport roller by the feed roller connected to the transport motor. When the printing sheet is transported to the position of the paper transport roller, the transport motor is detached from the feed roller and then the printing sheet is subsequently transported by the paper transport roller.

In the printer described in JP-A-2006-117385, the feed roller and the paper transport roller are rotationally driven by separate motors. That is, the feed roller is rotationally driven by a feeding motor and the paper transport roller is rotationally driven by a transport motor. In the printer, similar to the printer described in JP-A-2003-72964, a printing sheet is transported to a position of the paper transport roller by the feed roller and then the printing sheet is subsequently transported by the paper transport roller.

In the recent market of printers, the enhancement in throughput (number of printed sheets per unit time) in a continuous printing operation of continuously performing a printing operation on plural printing sheets was required. However, in the printers described in JP-A-2003-72964 and JP-A-2006-117385, a printing sheet is fed to a position of the paper transport roller by the feed roller and then the printing sheet is subsequently transported by the paper transport roller. That is, a printing operation or a paper discharging operation is independent from a feeding operation. Accordingly, in the printers described in JP-A-2003-72964 and JP-A-2006-117385, the enhancement in throughput is restricted.

### SUMMARY

An advantage of some aspects of the invention is to provide a printer having a configuration which can enhance a throughput and to provide a method of controlling a printer which can enhance a throughput.

According to an aspect of the invention, there is provided a method of controlling a printer including a feeder on which plural printing mediums are set, a first roller operable to pickup the plural printing mediums one by one from the feeder and a second roller operable to transport the plural printing mediums together with the first roller, the plural printing mediums include at least one first medium and a second medium subsequent to the first medium, the method comprising:

controlling the first and second rollers so that a peripheral speed of the first roller and a peripheral speed of the second roller are equal to each other; and

controlling the feeder so that the first roller cannot pickup the second medium from the feeder when receiving the printing instruction for performing the printing operation to only the first medium.

The present disclosure relates to the subject matter contained in Japanese patent application No. 2006-267608 filed on Sep. 29, 2006, which is expressly incorporated herein by reference in its entirety.

### BRIEF DESCRIPTION OF THE DRAWINGS

The invention will be described with reference to the accompanying drawings, wherein like numbers reference like elements.

FIG. 1 is a side view schematically illustrating a part of a printer according to an embodiment of the invention.

FIG. 2 is a diagram schematically illustrating a driving unit such as a PF driving roller shown in FIG. 1.

FIGS. 3A, 3B and 3C are diagrams illustrating an operation of a rear feed unit shown in FIG. 1.

FIG. 4 is a block diagram schematically illustrating a control unit shown in FIG. 2 and peripheral devices thereof.

FIGS. 5A, 5B, 5C and 5D are diagrams illustrating a transport control on a printing sheet in the printer shown in FIG. 1.

FIG. 6 is a flowchart illustrating a flow of a teed process in the printer shown in FIG. 1.

FIG. 7 is a flowchart illustrating a flow of a paper transport process in the printer shown in FIG. 1.

FIG. 8 is a flowchart illustrating a flow of a discharge process in the printer shown in FIG. 1.

FIG. 9 is a diagram illustrating a problem when the transport control on the printing sheet according to the embodiment of the invention is not employed.

### DESCRIPTION OF EXEMPLARY EMBODIMENTS

Hereinafter, embodiments of the invention will be described with reference to the drawings.

(Configuration of Printer)

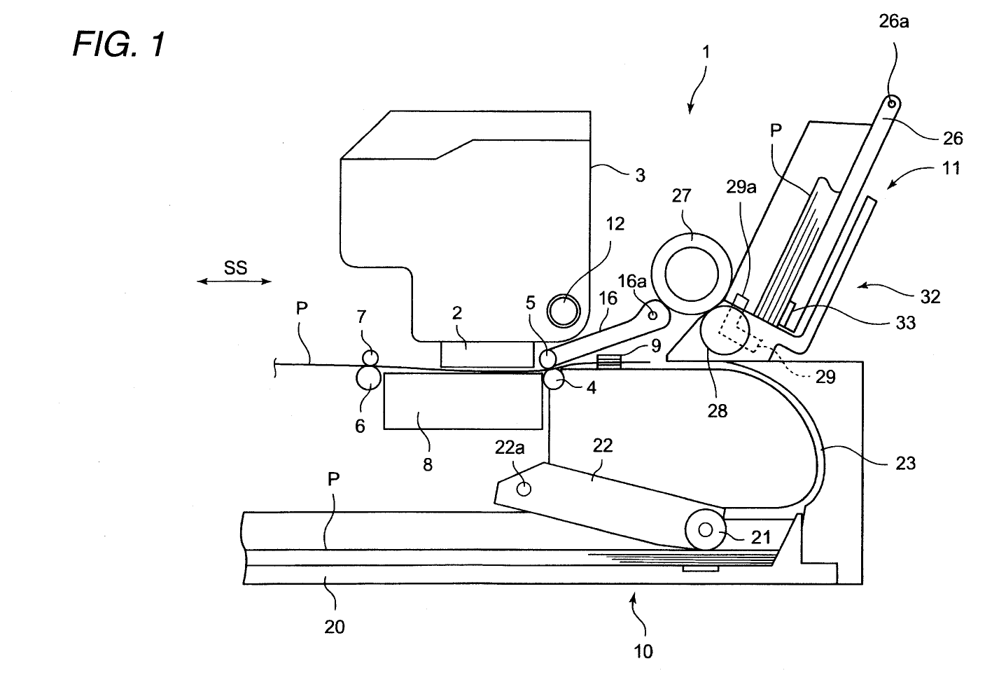

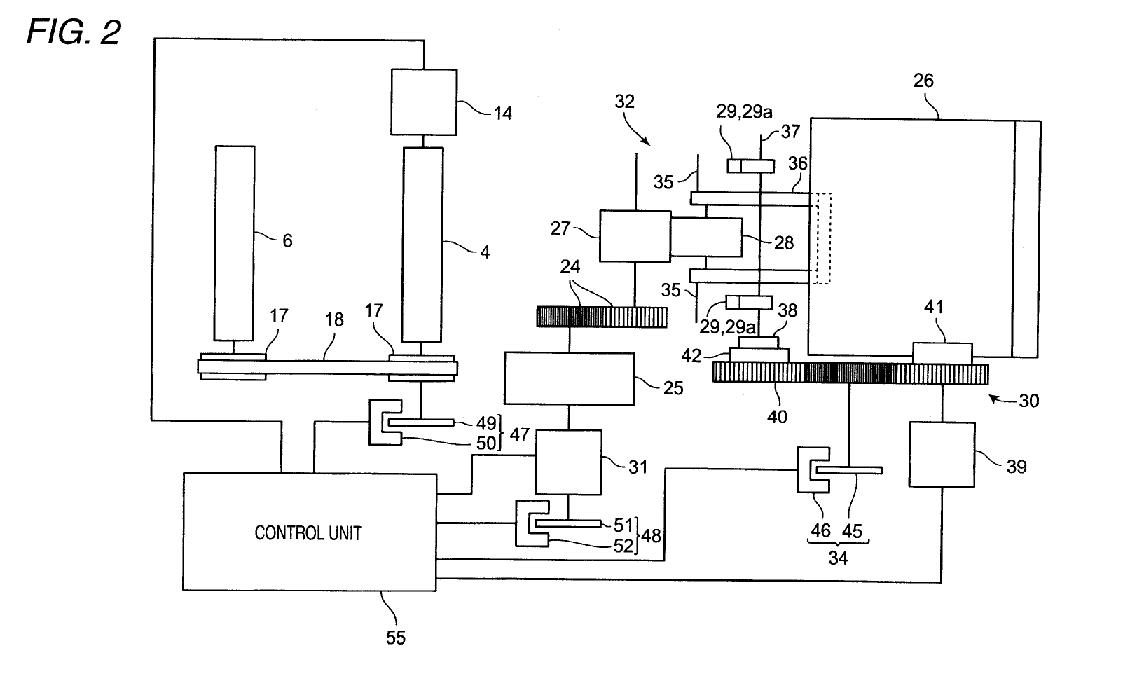

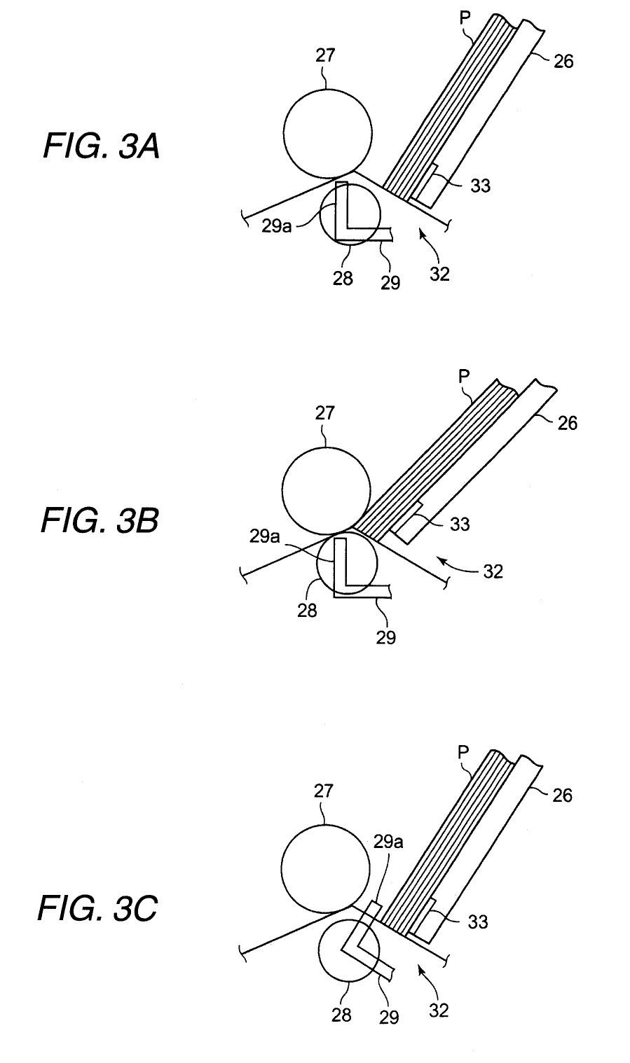

FIG. 1 is a side view schematically illustrating a part of a printer 1 according to an embodiment of the invention. FIG. 2 is a diagram schematically illustrating a driving system such as a PF driving roller 4 shown in FIG. 1, FIGS. 3A, 3B and 3C are diagrams illustrating an operation of a rear feed unit 32 shown in FIG. 1, where FIG. 3A shows an initial state of the rear feed unit 32, FIG. 3B shows a state where a printing sheet can be fed from the rear feed unit 32, and FIG. 3C shows a state where the printing sheet P is returned to a feed hopper by a paper returning lever 29.

The printer 1 according to this embodiment is an ink jet printer for performing a printing operation by ejecting ink droplets to a printing sheet P as a printing medium and is configured to feed the printing sheet P from both sides of a front side (the left side in FIG. 1) and a rear side (the right side in FIG. 1). The printer 1, as shown in FIG. 1, includes a carriage 3 mounted with a print head 2 for ejecting ink droplets, a PF driving roller 4 for transporting a printing sheet P fed from a feed hopper 26 to be described later in a sub scanning direction SS, a PF follower roller 5 for transporting the printing sheet P in cooperation with the PF driving roller 4, a discharge driving roller 6 and a discharge follower roller 7 for discharging the printing sheet P from the printer 1, a platen 8 opposed to an ink ejection surface (lower surface in FIG. 1) of the print head 2, a paper detector (PE sensor) 9 for detecting the printing sheet P fed from the feed hopper 26 or the like, a front feed mechanism 10 for feeding the printing sheet P from the front side to a printing area on which a printing operation is performed by the print head 2, and a rear feed mechanism 11 for feeding the printing sheet P from the rear side to the printing area. The printing medium of this embodiment includes a transparent film such as a sticker or an OHP film, in addition to a regular paper used for a regular document print, a photo paper used for a photo print, and a paperboard thicker than the regular paper and the photo paper.

The carriage 3 is connected to a carriage motor (CR motor) not shown. The carriage is driven by the CR motor and is guided by a guide shaft 12, thereby moving in a main scanning direction (a direction perpendicular to the paper surface of FIG. 1). An edge detector (PW sensor) (not shown) for detecting an edge of a printing sheet P is attached to the carriage 3. Plural ink ejection nozzles (not shown) are formed in the print head 2.

The surface of the PF driving roller 4 is coated with a high frictional material hating a high frictional coefficient. As shown in FIG. 2, the PF driving roller 4 is connected to a feed motor (PF motor) 14 as directly or through a gear not shown. The PF motor 14 in this embodiment is a DC (Direct Current) motor. In this embodiment, a method of controlling the PF motor 14 employs a PWM (Pulse Width Nodulation) control which is one kind of voltage control and a PID control for allowing a current rotation speed of the PF motor 14 to converge to a target rotation speed in combination of a proportional control, an integral controls and a derivative control.

As shown in FIG. 1, the PF follower roller 5 is rotatably held on the paper discharge side of a follower roller holder 16 which is pivotable about a rotation pivot 16a and is urged toward the PF driving roller 4 by a spring not shown. The PF follower roller 5 rotates with the rotation of the PF driving roller 4. The PF follower roller 5 and the PF driving roller 4 are disposed closer to the rear side than the print head 2 is.

As shown in FIG. 2, the discharge driving roller 6 is connected to the PF driving roller 4 through a transmission mechanism such as a pulley 18 or a belt 19 and is driven by the PF motor 14. The rotation of the discharge driving roller 6 is synchronized with the rotation of the PF driving roller 4. That is, the discharge driving roller 6 rotates substantially at the same peripheral speed as the peripheral speed of the PF driving roller 4. A discharge follower roller 7 is always urged toward the discharge driving roller 6 by a spring not shown and rotates along with the discharge driving roller 6. The discharge driving roller 6 and the discharge follower roller 7 are disposed closer to the front side (discharge side) than the print head 2 is.

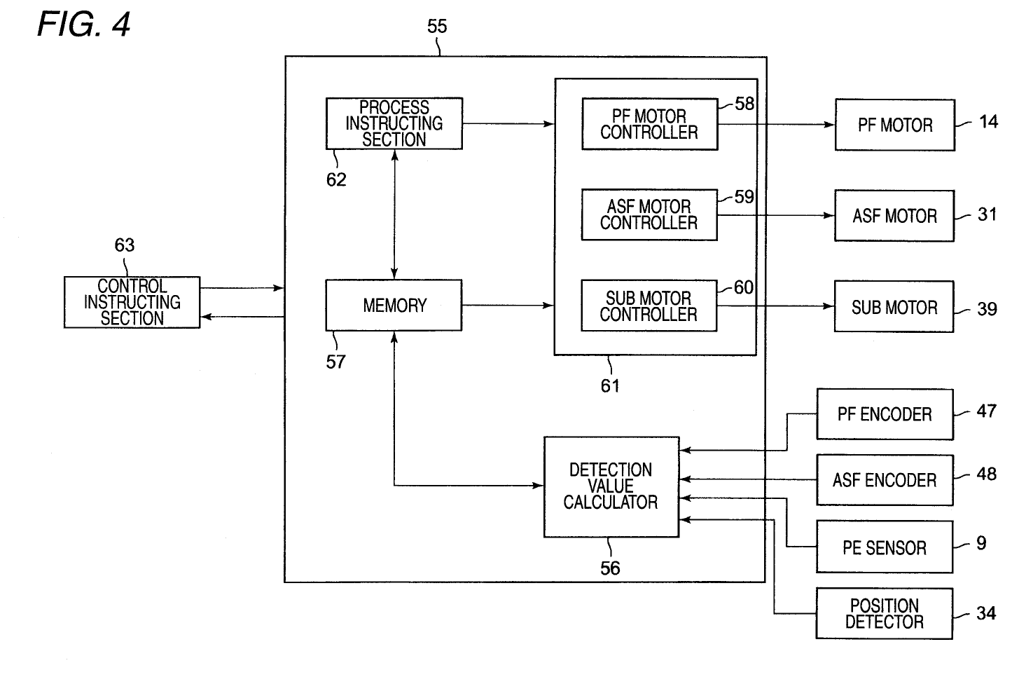

The PE sensor 9 is an optical detector in which a light-emitting element and a light-receiving element not shown are disposed vertically opposite each other and detects an edge in the width direction of the printing sheet P passing between the light-emitting element and the light-receiving element. The PE sensor 9 is disposed between the PF driving roller 4 and the rear feed mechanism 11 which are closer to the rear side than the carriage 3 is. The detection signal of the PE sensor 9 is input to the control unit 55 performing a variety of controls on the printer 1 (see FIG. 4).

The front feed mechanism 10 includes a front feed cassette 20 in which blank printing sheets P to be supplied front the front side are set, a front feed roller 21 that feeds the printing sheets P set in the front teed cassette 20 into the printer 1 (that is, toward a printing area on which a printing operation is performed by the print head 2), and a transport path 23 through which the printing sheets P fed from the front side pass. The front feed roller 21 is attached to an end of an arm 22 that is pivotable about a rotation pivot 22a and is pressed on the top surface of the printing sheet P. The front feed roller 21 transports the printing sheets P into the printer 1 until the leading end edge of the respective printing sheets P reaches the PF driving roller 4.

The rear teed mechanism 11 includes a feed hopper 26 on which blank printing sheets P to be fed from the rear side are placed, a rear feed roller 27 that feeds the printing sheets P placed on the feed hopper 26 to the printing area, a retard roller 28 serving to prevent a double transport of the printing sheets P (a phenomenon that plural printing sheets P are fed from the feed hopper 26 at a time) and feeding the printing sheets P along with the rear feed roller 27, and a paper returning lever 29 that comes in contact with the leading end edge of the printing sheet other than the designated number of printing sheets P and returns the printing sheet to the feed hopper 26. In this embodiment, a rear feed unit 32 in which the blank printing sheets are set is constituted by the feed hopper 26, the retard roller 28, and the paper returning lever 29.

The feed hopper 26, the retard roller 28, and the paper returning lever 29 are configured to pivotable as described later. Accordingly, the rear feed mechanism 11, as shown in FIG. 2, includes a driving mechanism 30 for allowing the feed hopper 26, the retard roller 28, and the paper returning lever 29 to pivot and a position detector 34 that detects the states of the feed hopper 26, the retard roller 28, and the paper returning lever 29.

The rear feed roller 27 is connected to an ASF motor 31 through a gear train 24 and a planet gear train 25, as shown in FIG. 2. The front feed roller 21 is also connected to the ASF motor 31 through the planet gear train 25 or the like (the front feed roller 21 is not shown in FIG. 2). In this embodiment, when the ASF motor 31 rotates in one direction by means of the action of the planet gear train 25, the rear feed roller 27 rotates and a printing sheet P is fed into the printer 1 from the rear side. When the ASF motor 31 rotates in the opposite direction, the front feed roller 21 rotates and a printing sheet P is fed into the printer 1 from the front side. The ASF motor 31 in this embodiment is a DC motor and is controlled in a PWM manner and in a PID manner, similarly to the PF motor 14.

The feed hopper 26 is a plate-like member on which printing sheets P can be placed and is pivotable about the rotation pivot 26a disposed at the topper end thereof. A frictional member 33 made of a material such as cork having a relatively high frictional coefficient is attached to the lower end of a surface of the feed hopper 26 on which the printing sheet P is placed, so as to prevent the double transport of the printing sheets P along with the retard roller 28.

The retard roller 28 is disposed at a position opposed to the lower side or the slope of the rear feed roller 27. The outer periphery of the retard roller 28 is made of a member having a high frictional coefficient. The retard roller 28 is rotatably held by an arm 36 which is pivotable about a predetermined rotation pivot, as shown in FIG. 2. An end of the arm 36 (the right end in a FIG. 2) is in contact with the feed hopper 26 in a state where it is urged toward the feed hopper 26.

The paper returning lever 29 includes a claw portion 29a for hooking and returning the leading end edge (the lower side in FIG. 1) of the remaining printing sheet P to the feed hopper 26. The paper returning lever 29, as shown in FIG. 2, is pivotable about a predetermined rotation pivot 37. A contact member 38 coming in contact with a second cam 42 to be described later is fixed to an end of the rotation pivot 37.

As shown in FIG. 2, the driving mechanism 30 includes a sub motor (ASF sub motor) 39 for driving the rear feed unit 32 and a gear train 40 connected to the sub motor 39. The sub motor 39 in this embodiment is a DC motor and is controlled in a PWM manner. A first cam 41 coming in contact with the feed hopper 26 to pivot the feed hopper 26 is formed in one gear of the gear train 40 and a second cam 42 coming in contact with the contact member 38 to pivot the paper returning lever 29 is formed in another gear.

The feed hopper 26 pivots about the rotation pivot 26a by means of the rotational motion of the first cam 34. The lower end of the feed hopper 26 is urged to the rear feed roller 27 and gets away from the rear feed roller 27 by means of the pivoting. The paper returning lever 29 pivots about the rotation pivot 37 by means of the action of the contact member 38 accompanied with the rotational motion of the second cam 42. By means of the pivoting, the claw portion 29a retreats at the time of feeding a printing sheet and the claw portion 29a goes up after feeding the printing sheet, thereby returning the remaining printing sheet P to the feed hopper 26. The arm 36 holding the retard roller 28 also pivots along with the feed hopper 26 pivoting with the rotational motion of the first cam 41. By means of the pivoting, the retard roller 28 comes in contact with the rear feed roller 27 with a predetermined pressure and gets away from the rear feed roller 27.

Specifically, as shown in FIG. 3A, the state where the lower end of the feed hopper 26 and the retard roller 28 go down and the claw portion 29a of the paper returning lever 29 retreats is assumed as the initial state. Then, when the first cam 41 and the second cam 42 are driven by the sub motor 39 so as to rotate by a predetermined angle from the initial state, the lower end of the feed hopper 26 goes up and is urged to the rear teed roller 27, as shown in FIG. 3B. That is, the printing sheets P placed on the feed hopper 26 are urged to the rear feed roller 27. The retard roller 28 goes up and is pressed against the rear feed roller 27. At this times the claw portion 29a of the paper returning lever 29 is maintained in a retreating state similar to the initial state.

In the state shown in FIG. 3B, the printing sheets can be fed from the rear side. When the rear feed roller 27 rotates in this state, the uppermost printing sheet P of the printing sheets P placed on the feed hopper 26 is transported to the discharge side through the contact portion between the rear feed roller 27 and the retard roller 28. The second printing sheet P from the uppermost is prevented from being transported to the discharge side by means of the action of the retard roller 28.

When the first cam 41 and the second cam 42 further rotate by a predetermined angle from the state shown in FIG. 3B, the lower end of the feed hopper 26 goes down and gets away from the rear feed roller 21, as shown in FIG. 3C. That is, the printing sheets P placed on the feed hopper 26 get away from the rear feed roller 27. The retard roller 28 also goes down and gets away from the rear feed roller 27. The claw portion 29a goes up and returns the remaining printing sheet P to the feed hopper 26. That is, in the state shown in FIG. 3C, the printing sheets P cannot be fed from the rear feed unit 32. When the first cam 41 and the second cam 42 further rotate by a predetermined angle from the state shown in FIG. 3C, the state is returned to the initial state shown in FIG. 3A. In the initial state shown in FIG. 3A, the printing sheets P cannot be fed from the rear feed unit 32.

The position detector 34 is an optical detector including a detection plate 45 rotating along with one gear of the gear train 40 and a photo sensor 46. The detection plate 45 has a detection portion (not shown) protruding outwardly in the diameter direction. The photo sensor 46 has a light-emitting element and a light-receiving element (not shown) opposed to each other so as to detect the detection portion and outputs a detection signal of which the level varies depending on the existence and absence of the detection portion. The detection signal of the photo sensor 46 (that is, the detection signal of the position detector 34) is input to the control unit 55 performing various controls on the printer 1.

The printer 1 according to this embodiment includes a PF encoder 47 for detecting a rotation distance and a rotation speed of the PF motor 14 (that is, the transport distance and the transport speed of the printing sheet P by the PF driving roller 4) and an ASF encoder 48 for detecting a rotation distance and a rotation speed of the ASE motor 31 (that is, the transport distance and the transport speed of the printing sheet P by the rear feed roller 27).

The PB encoder 47 includes a rotary scale 49 fixed to the rotation axis of the PF driving roller 4 and a photo sensor 50 having a light-emitting element and a light-receiving element not shown with the outer periphery of the rotary scale 49 interposed therebetween. Plural slits are arranged at a constant pitch in the peripheral direction on the peripheral edge of the rotary scale 49. The photo sensor 50 outputs a pulse-like detection signal of which the level varies depending on the pitch of the slits with the rotation of the rotary scale 49. The output signal from the photo sensor 50 (that is, the detection signal of the PF encoder 47) is input to the control unit 55.

The ASF encoder 48 includes a rotary scale 51 fixed to the output axis of the ASF motor 31 and a photo sensor 52 having a light-emitting element and a light-receiving element not shown with the outer periphery of the rotary scale 51 interposed therebetween. Similarly to the rotary scale 49, plural slits are formed in the rotary scale 51. Similarly to the photo sensor 50, the photo sensor 52 outputs a pulse-like detection signal. The detection signal of the photo sensor 52 (that is, the detection signal of the ASF encoder 48) is input to the control unit 55.

(Configuration of Control Unit)

FIG. 4 is a block diagram schematically illustrating a configuration of the control unit 55 shown in FIG. 2 and the peripheral devices thereof. FIG. 4 shows only configurations of the control unit 55 associated with the control of the PF motor 14, the ASF motor 31, and the sub motor 39.

As the configurations associated with the control of the PF motor 14, the ASF motor 31, and the sub motor 39, the control unit 55 includes a motor controller 61 having a detection value calculator 56 for receiving various detection signals and calculating various detection values, a memory 57 for storing various information for controlling the PF motor 14, etc., a PF motor controller 58 for controlling the PF motor 14, an ASF motor controller 59 for controlling the ASF motor 31, and a motor controller 61 for controlling the sub motor 39 and a process instructing section 62 for instructing various processes to the motor controller 61. A control instructing section 63 is connected to the control unit 55 through an input/output unit not shown.

The detection value calculator 56 and the process instructing section 62 are actually embodied by calculation means such as a CPU constituting the control unit 55 and input/output means such as an IO port. The memory 57 is embodied by a storage unit such as a ROM, a RAM, and a non-volatile memory. The PF motor controller 58, the ASF motor controller 59, and the submotor controller 60 are embodied by a predetermined motor driving circuit and the like.

The detection signals of the PF encoder 47, the ASF encoder 48, and the position detector 34 are input to the detection value calculator 56. The detection value calculator 56, on the basis of the detection signals, generates various detection values and updates various information stored in the memory 57. For example, the detection value calculator 56 periodically generates various detection values and updates the information in the memory 57 with a PID control period of the PF motor 14 and the like.

Specifically, the detection value calculator 56 generates the detection values of the rotation distance and the rotation speed of the PF motor 14 (that is, the transport distance and the transport speed of the printing sheet P by the PF driving roller 4) on the basis of the number of pulses of the pulse-like detection signal output from a the PF encoder 47 and stores the detection values in the memory 57. Similarly, the detection value calculator 56 generates the detection values of the rotation distance and the rotation speed of the ASF motor 31 (that is, the transport distance and the transport speed of the printing sheet P by the rear feed roller 27) on the basis of the number of purses of the pulse-like detection signal output from the ASF encoder 48 and stores the detection values in the memory 57. The detection value calculator 56 judges the state of the rear feed unit 32 on the basis of the detection signal of the position detector 34 and stores the state in the memory 57.

The detection value calculator PE judges whether the printing sheet P is detected by the PE sensor 9 on the basis of the detection signal of the PE sensor 9 and stores the state in the memory 57. When the leading end edge of the printing sheet P is detected by the PE sensor 9, the detection value calculator 56 generates the detection value of the transport distance of the printing sheet P by the PF driving roller 4 after the detection on the basis of the number of pulses of the detection signal of the PF encoder 47, generates the detection value of the transport distance of the printing sheet P by the rear teed roller 27 after the detection on the basis of the number of pulses of the detection signal of the ASF encoder 48, and stores the detection values in the memory 57.

The process instructing section 62 instructs the motor controller 61 for performing a feed process of feeding the blank printing sheet P from the feed hopper 26 or the like to the printing area, a paper transport process of intermittently transporting the printing sheet P under print by a predetermined distance, and a discharge process of discharging the printing sheet P in the printing area to the outside of the printer 1. Specifically, the process instructing section 62 instructs the PF motor controller sa or the ASF motor controller 59 to generate a PID control signal, as described below.

As described above, the PF motor 14 of this embodiment is controlled in the PID control manner. Accordingly, the PF motor controller 58 generates a PID control signal for the PF motor 14 and outputs the PID control signal to the PF motor 14. Specifically, a target speed table in which target rotation speeds relative to rotation distances of the PF motor 14 are set is stored in the memory 57. The PF motor controller 58 generates the PID control signal for the PF motor 14 in response to an instruction from the process instructing section 62 based on the information on the rotation distance and the rotation speed of the PF motor 14 stored in the memory 57 and the information in the target speed table. Since the PF motor 14 of this embodiment is controlled in the PWM control manner, the PID control signal is a pulse-like signal in which ON and OFF are repeated with a predetermined switching period. Since the ASF motor 31 of this embodiment is controlled in the PID control manner, the ASF motor controller 59 generates the PID control signal for the ASF motor 31 and outputs the PID control signal to the ASF motor 31, similarly to the PF motor controller 58. Since the sub motor 39 is controlled in the PWM control manner as described above, the sub motor controller 60 outputs the PWM driving signal to the sub motor 39 in response to the instruction from the process instructing section 62.

The control instructing section 63 instructs a printing instruction for performing a printing operation on the printing sheet P to the control unit 55. The printing instruction includes a variety of information such as a size of the printing sheet P to be subjected to the printing operation, an intermittent transport distance (instructed intermittent transport distance) of the printing sheet P at the time of performing the printing operation, the number of printing sheets, and the print pattern.

(Operation of Printer)

In the printer 1 having the above-mentioned configuration, the printing sheet P fed into the printer 1 from the front feed cassette 20 through the front feed roller 21 or the printing sheet P fed into the printer 1 from the rear feed hopper 26 through the rear feed roller 27 is intermittently transported in the sub scanning direction SS by the PT driving roller 4 and the like. When the intermittent transport is stopped, the carriage 3 reciprocates in the main scanning direction. When the carriage 3 reciprocates, ink droplets are ejected from the print head 2 to perform a printing operation on the printing sheet P. When the printing operation on the printing sheet P is ended, the printing sheet P is discharged out of the printer 1 by the discharge driving roller 6 and the like.

In this embodiment, when the plural printing sheet P fed from the rear side are subjected to a printing operation in a draft print mode in which a high-speed printing operation is performed by sating ink consumption instead of lowering the resolution at the time of continuously performing a printing operation on the plural printing sheets P, the rear feed roller 27 is used in addition to the PF driving roller 4 and the discharge driving roller 6 is used to intermittently transport the printing sheets P after the printing sheet is transported from the feed hopper 26 to the PF driving roller 4 by the rear feed roller 27. At the time of continuously performing the printing operation in the draft print mode, the printing sheets P are intermittently transported during the printing operation performed by the carriage in cooperation of the PF driving roller 4 and the discharge driving roller 6 driven by the PF motor 14 with the rear feed roller 27 driven by the ASF motor 31. Accordingly, at the time of continuously performing the printing operation in the draft print mode, the PF driving roller 4 and the discharge driving roller 6 are made to rotate in synchronization with the rear feed roller 27 (that is, at the same peripheral speed).

Specifically, the target speed tables of the PF motor 14 and the ASF motor 31 are set and stored in the memory so that the speed profile representing a relation between the rotation distance of the PF driving roller 4 and the target peripheral speed (that is, the target transport speed of the printing sheet P by the PF driving roller 4) is substantially equal to the speed profile representing a relation between the rotation distance of the rear feed roller 27 and the target peripheral speed (that is, the target transport speed of the printing sheet P by the rear feed roller 27). In this embodiment, the target speed table of the ASF motor 14 is set on the basis of the target speed table of the PT motor 14. The PF motor 14 and the ASF motor 31 are controlled in the PID control manner on the basis of the target speed tables. Now, the method of controlling the transport of a printing sheet P in this embodiment will be described with reference to the transport control of the printing sheet P when the printing sheet P is fed from the rear side.

(Method of Controlling Transport of Printing Sheets

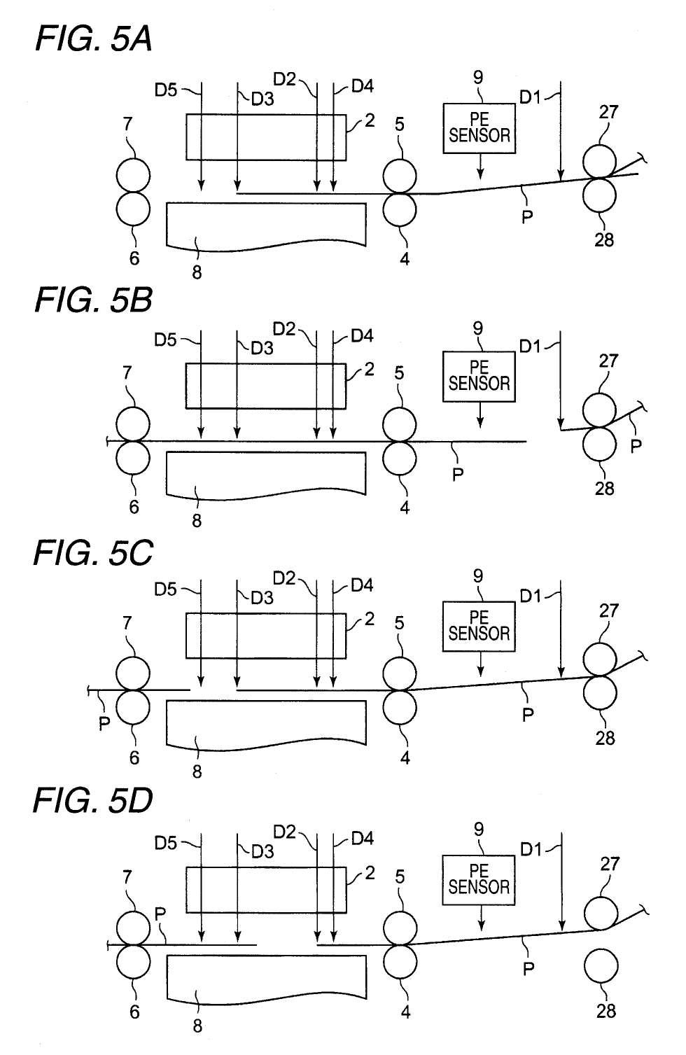

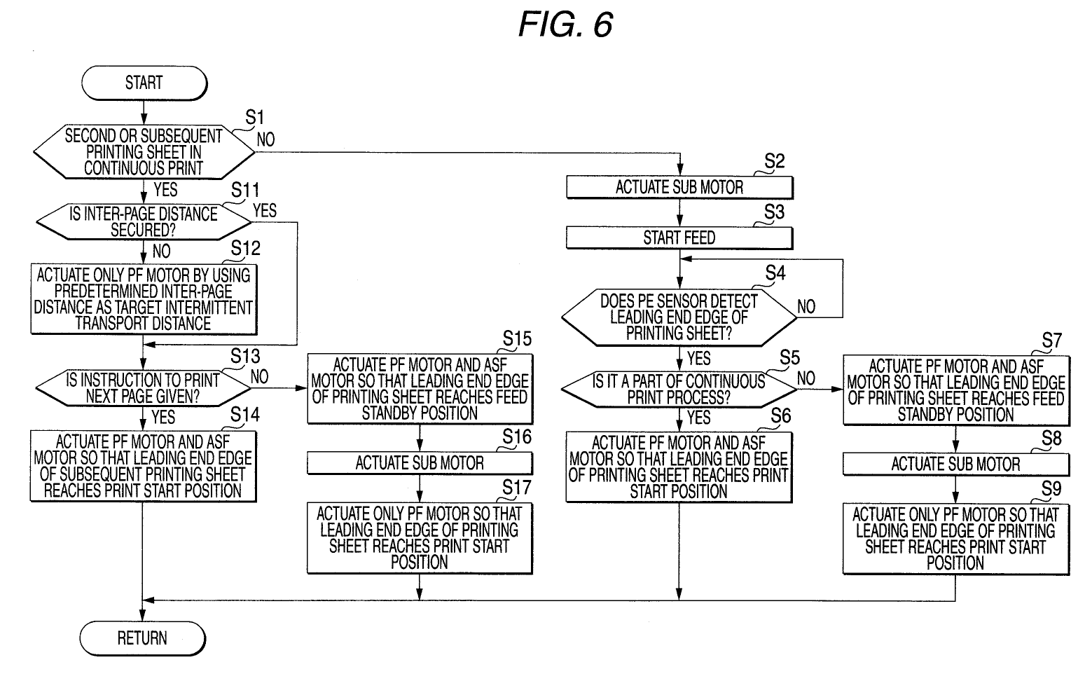

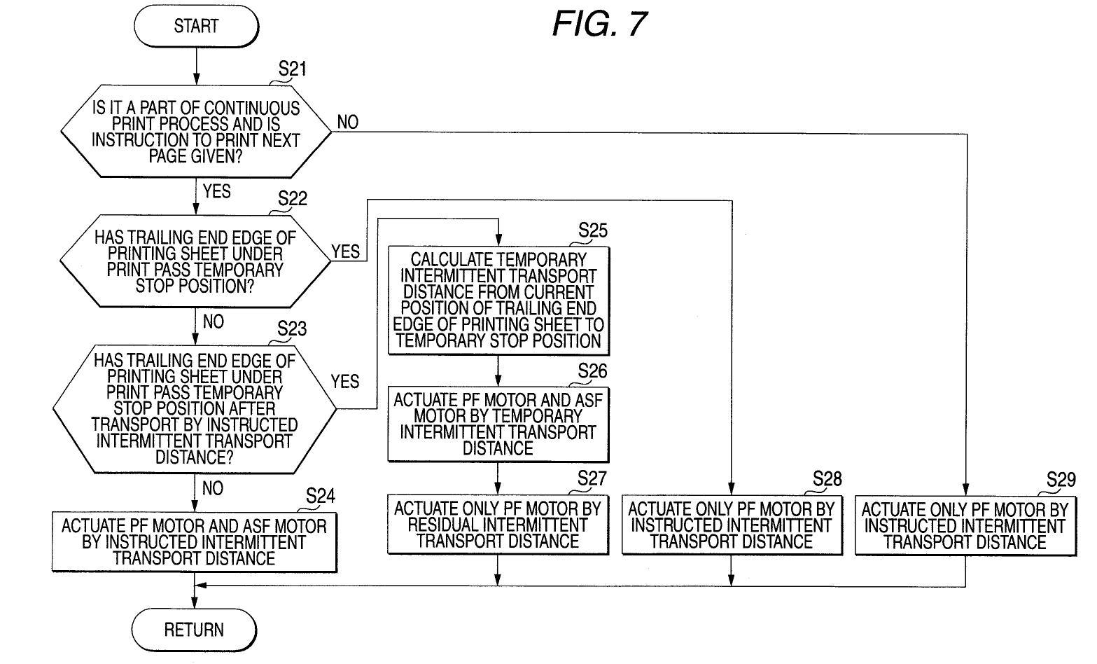

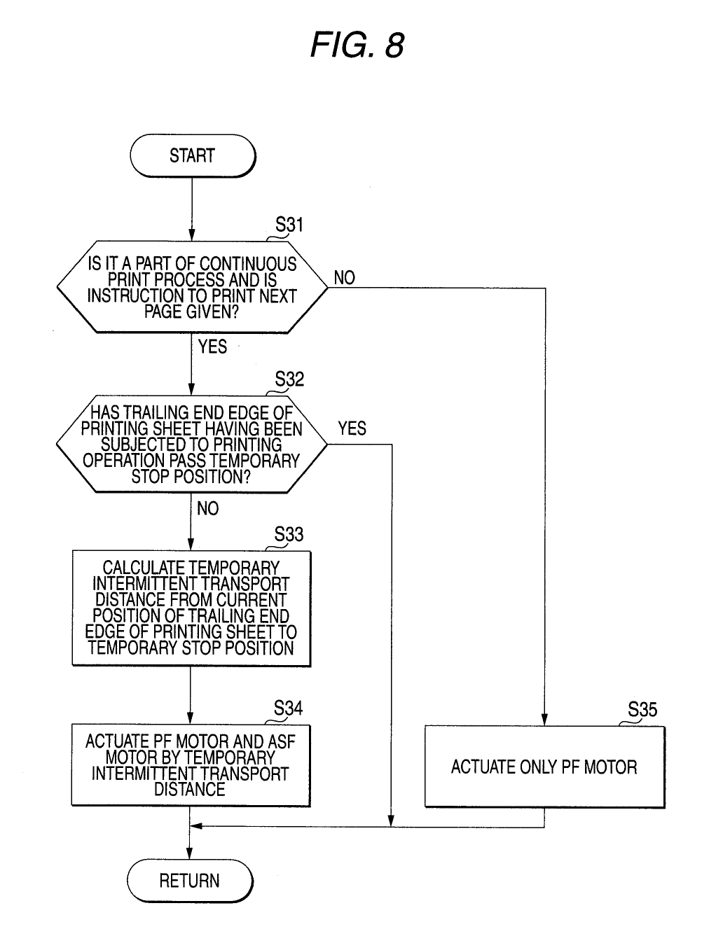

FIGS. 5A, 5B, 5C and 5D are diagrams illustrating the transport control of a printing sheet P in the printer shown in FIG. 1, wherein FIG. 5A shows a state where the first printing sheet P in a continuous print process has been transported to a print start position D3, FIG. 5B shows a state where the second or subsequent printing sheet P in the continuous print process stays at a temporary stop position D1, FIG. 5C shows a state where the second or subsequent printing sheet P in the continuous print process has been transported to the print start position D3, and FIG. 5D shows a state where the final printing sheet P in the continuous print process has been transported to a feed standby position D2. FIG. 6 is a flowchart illustrating a flow of the feed process of the printer 1 shown in FIG. 1. FIG. 7 is a flowchart illustrating a flow of the paper transport process of the printer 1 shown in FIG. 1. FIG. 8 is a flowchart illustrating a flow of the discharge process of the printer 1 shown in FIG. 1.

In this embodiment, control reference positions are set in the transport path of the printing sheet P so as to execute the transport control of the printing sheet P fed from the rear side. Specifically, as shown in FIGS. 5A to 5D, the temporary stop position D1 at which the printing sheets P are temporarily stopped in order to secure a predetermined inter-page distance between the second or subsequent printing sheet P and the previous printing sheet P in the continuous print process; the feed standby position D2 as a target stop position of the leading end edge of the printing sheet P right before being subjected to the printing operation in print modes other than the draft print mode or at the time of performing a printing operation on only one printing sheet P; and the print start position D3 as a target stop position of the leading end edge of the printing sheet P at the time of starting the print process on the printing sheets P are set in the transport path of the printing sheet P. In this embodiment, the feed standby position D2 serves as a predetermined reference position at which the leading end edge of the final printing sheet P in the continuous print process is stopped so as to drive the rear feed unit 32 from the state shown in FIG. 3S to the state shown in FIG. 3C as described later.

An upstream nozzle position D4 which is a position of an ink ejection nozzle disposed on the most upstream side (the feed side of the printing sheet P) in the transport direction of the printing sheet P among the plural ink election nozzles (not shown) formed in the print head 2 and a downstream nozzle position D5 which is a position of an ink ejection nozzle disposed on the most downstream side (the discharge side of the printing sheet P) in the transport direction of the printing sheet P among the plural ink ejection nozzles formed in the print head 52 are shown in FIGS. 5A to 5D.

The temporary stop position D1 is set between the rear feed roller 27 and the PF driving roller 4. The feed standby position D2 is set to a position apart downstream by a predetermined distance (for example, 3 to 5 mm) from the upstream nozzle position D4. The print start position D3 is set to a position apart upstream by a predetermined distance (for example, 3 to 5 mm) from the downstream nozzle position D5.

The transport control of the printing sheet P in the printer 1 using the control reference positions D1 to D3 are performed as follows. Hereinafter, the transport control of the printing sheet P is described with reference to three processes of the feed process, the paper transport process, and the discharge process.

When a printing instruction for n (where n is an integer of 1 or greater) printing sheets is input to the control unit 55 from the print instructing section 63 (printing instruction input step), the process instructing section 62 and the like perform the feed process shown in FIG. 6. That is, the process instructing section 62 first judges whether this feed process is a process on the second or subsequent printing sheet P in the continuous print process (step S1). When the process instructing section 62 judges in step S1 that this feed process is a process on the first printing sheet P in the continuous print process or that this feed process is a process on the printing sheet P at the time of performing a printing operation on only one printing sheet, the process instructing section 62 instructs the sub motor controller 60 to actuate the sub motor 39 and the sub motor controller 60 actuates the sub motor 39 (step S2). Specifically, the sub motor controller 60 actuates the sub motor 39 to change the rear feed unit 32 from the initial state shown in FIG. 3A to the state shown in FIG. 3B.

Thereafter, the ASF motor controller 59 actuates the ASF motor 31 in response to the instruction from the process instructing section 62 (step S3). That is, in step S3, the rear feed roller 27 rotates with the actuation of the ASF motor 31 and the feed process is started. In step S3, the process instructing section 62 instructs the PF motor controller 58 to actuate the PF motor 14 and the PF motor controller 58 actuates the PF motor 14. At this time, the PF motor 14 and the ASF motor 31 are actuated so that the peripheral speed of the PF driving roller 4 and the peripheral speed of the rear feed roller 27 are substantially equal to each other.

Thereafter, the process instructing section 62 judges whether the PE sensor 9 has detected the leading end edge of the printing sheet P on the basis of the information stored in the memory 57 (step S4). In step S4, when the process instructing section 62 judges that the PE sensor has detected the leading end edge of the printing sheet P, the process instructing section 62 judges whether this feed process is a part of the continuous print process (step 5).

When it is judged in step S4 that the PE sensor 9 has detected the leading end edge of the printing sheet P, the detection value calculator 56 generates the detection value of the transport distance of the printing sheet P by the PF driving roller 4 after the detection of the PE sensor 9 (hereinafter, referred to as after-PE-detection PF transport distance) on the basis of the detection signal of the PF encoder 47, generates the detection value of the transport distance of the printing sheet P by the rear feed roller 27 after the detection of the PE sensor 9 (hereinafter, referred to as after-PE-detection ASF transport distance) on the basis of the detection signal of the ASF encoder 48, and updates the information on the after-PE-detection PF transport distance and the information on the after-PE-detection ASE transport distance stored in the memory 57.

When the process instructing section 62 judges in step S5 that this feed process is a part of the continuous print process, as shown in FIG. 5A, the ASF motor controller S5 actuates the ASF motor 31 and the PF motor controller 56 actuates the PF motor 14, until the leading end edge of the printing sheet P stops at the position substantially equal to the print start position D3. When the printing sheet P is transported to a position at which the leading end edge of the printing sheet P is substantially equal to the print start position D3, the ASF motor controller 59 deactuates the ASF motor 31 and the PF motor controller 58 deactuates the P motor 14 (step S6), in response to the instruction of the process instructing section 62. When the PF motor 14 and the ASF motor 31 are deactuated in step S6, the feed process on the first printing sheet P is ended.

On the other hand, when the process instructing section 62 judges in step S5 that this teed process is not a part of the continuous print process (that is r a part of the print process on only one printing sheet), the ASF motor controller 59 actuates the ASF motor 31 and the PF motor controller 58 actuates the PF motor 14, until the leading end edge of the printing sheet P stops at the position substantially equal to the feed standby position D2. When the printing sheet P is transported to a position at which the leading end edge of the printing sheet P is substantially equal to the feed standby position D2, the PF motor controller 58 deactuates the P motor 14 and the ASF motor controller 59 deactuates the ASF motor 31 (step S7), in response to the instruction of the process instructing section 62. In response to the instruction from the process instructing section 62, the submotor controller 60 actuates the sub motor 39 (step S8). Specifically, the sub motor controller 60 actuates the sub motor 39 to change the rear feed unit 32 from the state shown in FIG. 3B to the state shown in FIG. 3C. In step S7, the leading end edge of the printing sheet P is positioned at the feed standby position D2 on the basis of the after-PE-detection ASE transport distance. That is, in step S8, the sub motor 39 is controlled to drive the rear feed unit 32 on the basis of the after-PE-detection ASF transport distance calculated by the PE sensor 9.

Thereafter, the process instructing section 62 gives an instruction to only the PF motor controller 58 and actuates only the PF motor 14 so that the printing sheet P is transported to the position at which the leading end edge of the printing sheet P is substantially equal to the print start position D3 (step S9). When the printing sheet P is transported to a position at which the leading end edge of the printing sheet P is substantially equal to the print start position D3 in step S9, the PF motor controller 5 deactuates the PF motor 14 in accordance with the instruction from the process instructing section 62. When the PF motor 14 is deactivated in step S9, the feed process on the printing sheet P is ended.

When the above-mentioned feed process is ended, the process instructing section 62 instructs a print controller not shown to perform a printing operation on the printing sheet P and the print controller drives the CR motor (not shown) or the plural ink ejection nozzles (not shown) to perform a predetermined printing operation. That is, the print controller performs a print process by one scanning of ejecting ink droplets from the ink ejection nozzles while allowing the carriage 3 to reciprocate once by the CR motor.

When the above-mentioned print process by one scanning is ended, the process instructing section 62 and the like performs the paper transport process shown in FIG. 7. That is, the process instructing section 62 first judge whether this paper transport process is a part of the continuous print process and an instruction to print a next page has been given (step S21). When the process instructing section 62 judges in step S21 that this paper transport process is a part of the continuous print process and an instruction to print a next page has been given, the process instructing section 62 judges whether the trailing end edge of the printing sheet P under print has passed the temporary stop position D1 (step S22). For example, the process instructing section 62 performs the judgment of step S22 on the basis of the information such as a size of the printing sheet P or the after-PE-detection PF transport distance included in the printing instruction from the control instructing section 63.

When this paper transport process is a first paper transport process on the printing sheet P and the process instructing section 62 judges in step s22 that the trailing end edge of the printing sheet P under print has not passed the temporary stop position D1, the process instructing section 62 judges whether the trailing end edge of the printing sheet P under print passes the temporary stop position D1 as a result of performing this paper transport process by an instructed intermittent transport distance based on the printing instruction from the control instructing section 63 (step S23). For example, the process instructing section 62 performs the judgment of step S23 on the basis of the information such as a size of the printing sheet P or the after-PE-detection PF transport distance included in the printing instruction of the control instructing section 63.

When the process instructing section 62 judges in step S23 that the trailing end edge of the printing sheet P under print does not pass the temporary stop position D1, the process instructing section 62 instructs the PD motor controller 58 and the ASF motor controller 59 to transport the printing sheet P by using the instructed intermittent transport distance as a target intermittent transport distance, and the PF motor controller 58 and the ASF motor controller 59 actuate the PF motor 14 and the ASF motor 31, respectively (step S24) so that the peripheral speed of the PF driving roller 4 is substantially equal to the peripheral speed of the rear feed roller 27 and so that the intermittent transport distance of the printing sheet P by the PF driving roller 4 is substantially equal to ID the intermittent transport distance by the rear feed roller 27. Hereinafter, the transport control of the printing sheet P is referred to as a synchronization control, in which the PF motor 14 and the ASF motor 31 are actuated so that the peripheral speed of the PF driving roller 4 is substantially equal to the peripheral speed of the rear feed roller 27 and so that the intermittent transport distance of the printing sheet P by the PF driving roller 4 is substantially equal to the intermittent transport distance by the rear feed roller 27.

More specifically, in step S24, the PF motor 14 is controlled so that the intermittent transport distance of the printing sheet P by the PF driving roller 4 is equal to the instructed intermittent transport distance and the intermittent transport distance of the printing sheet P by the rear feed roller 27 is slightly greater than the intermittent transport distance of the printing sheet P by the PF driving roller 4. For example, the intermittent transport distance of the printing sheet P by the rear feed roller 27 is greater by about 5% than the intermittent transport distance of the printing sheet P by the PF driving roller 4. In step S24, the startup of the PF motor 14 is slightly later than the startup of the ASF motor 31.

When the transport of the printing sheet P based on the instructed intermittent transport distance is ended in step S24, one paper transport process is ended. Then, a print process is performed in which the one paper transport process and the above-mentioned print process by one scanning (one-scanning print process are alternately repeated.

On the other hand, when the process instructing section 62 judges in step S23 that the trailing end edge of the printing sheet P under print passes the temporary stop position D1 by performing such a print process or due to the greater instructed intermittent transport distance, the process instructing section 62 calculates a temporary intermittent transport distance from the current position of the trailing end edge of the printing sheet P under print to the temporary stop position D1 (step S25. In accordance with the instruction from the process instructing section 62, the ASF motor controller 59 actuates the ASF motor 31 and the PF motor controller 58 actuates the PF motor 14 by using the temporary intermittent transport distance as the target intermittent transport distance, thereby transporting the printing sheet P to the position at which the leading end edge of the printing sheet P is substantially equal to the temporary stop position D1 (step S26). The synchronization control is performed in step S26. Accordingly, the leading end edge of the printing sheet P subsequent to the printing sheet P under print is transported to the position substantially equal to the temporary stop position D1.

Thereafter, the process instructing section 62 instructs only the PF motor controller 58 to actuate the only the PF motor 14 (step s27) so as to transport only the printing sheet P under print by using a residual intermittent transport distance, which is a difference between the instructed intermittent transport distance and the temporary intermittent transport distance, as the target intermittent transport distance. When the transport of the printing sheet P is ended in step S27, one paper transport process is ended.

By the processes of steps S25 to S27, as shown in FIG. 5B, a predetermined inter-page distance is secured between the trailing end edge of the printing sheet P under printer and the leading end edge of the subsequent printing sheet P. Accordingly, it is possible to properly detect the trailing end edge of the previous printing sheet P and the leading end edge of the subsequent printing sheet P by the use of the PE sensor 9.

When the process instructing section 62 judges in step S22 that the trailing end edge of the printing sheet P under print has passed the temporary stop position D1, such as when the paper transport process is performed after the process of step S27, the process instructing section 62 instructs only the PF motor controller 58 to actuate the PF motor 14 so as to transport only the printing sheet P under print by using the instructed intermittent transport distance as the target intermittent transport distance (step S28). When the transport of the printing sheet P is ended in step S28, one paper transport process is ended.

When the process instructing section 62 judges in step S21 that this paper transport process is not a part of the continuous print process or that an instruction to perform a next page is not given, the process instructing section 62 instructs only the PF motor controller 58 to actuate only the PF motor 14 so as to transport only the printing sheet P under print by using the instructed intermittent transport distance as the target intermittent transport distance (step S29). When such a judgment result is obtained in step S21, the paper transport process on the final printing sheet (that is, the n-th printing sheet) P of the continuous print process or on the first printing sheet P in a single sheet print process is performed in step S29. Accordingly, at the time of transporting the printing sheet P in step S29, as described in step S8, or as described in step S16 later, the rear feed unit 32 is in the state shown in FIG. 3C.

When the print process is ended in which one paper transport process and one-scanning print process are alternately repeated (that is, when the printing operation on one printing sheet P is ended), the process instructing section 62, etc. performs the discharge process shown in FIG. 8. That is, the process instructing section 62 judges whether this discharge process is a part of the continuous print process and an instruction to print a next page is given (step S31). When the process instructing section 62 judges in step S31 that this discharge process is a part of the continuous print process and an instruction to print a next page is given, the process instructing section 62 judges whether the trailing end edge of the printing sheet P having been subjected to the printing operation has passed the temporary stop position D1 (step S32). For example, the process instructing section 62 performs the judgment of step S32 on the basis of the information such as a size of the printing sheet P and the after-PE-detection PT transport distance included in the printing instruction from the control instructing section 63.

When the process instructing section 62 judges in step S32 that the trailing end edge of the printing sheet P having been subjected to a printing operation has not passed the temporary stop position D1, such as when the printing operation on the printing sheet P is ended in the halfway of the printing sheet P, the process instructing section 62 calculates the temporary intermittent transport distance from the current position of the trailing end edge of the printing sheet P having been subjected to the printing operation to the temporary stop position D (step S33). In accordance with the instruction from the process instructing section 62, the ASF motor controller 59 actuates the ASP motor 31 and the PF motor controller 58 actuates the PF motor 14 by using the temporary intermittent transport distance as the target intermittent transport distance, thereby transporting the printing sheet P to the position where the trailing end edge of the printing sheet P having been subjected to the printing operation substantially reaches the temporary stop position (step S34). The synchronization control is performed in step S34. Accordingly, the leading end edge of the printing sheet P subsequent to the printing sheet P under discharge is transported to the position substantially equal to the temporary stop position D1. When the PF motor 14 and the ASF motor 31 are deactuated in step S34, the discharge process is ended.

On the other hand, when the process instructing section 62 judges in step S32 that the trailing end edge of the printing sheet P having been subjected to the printing operation has passed the temporary stop position D1, such as when the printing operation on the printing sheet P is ended in the vicinity of the trailing and edge of the printing sheet P, the discharge process is ended without any specific instruction from the process instructing section 62.

When the process instructing section 62 judges in step S31 that this discharge process is not a part of the continuous print process or that an instruction to print a next page is not given, the process instructing section 62 instructs only the PF motor controller 58 to actuate only the PD motor 14, thereby performing the discharge process (step S35). When such a judgment result is obtained in step S31, the discharge process on the final printing sheet (that is, the n-th printing sheet) P in the continuous print process or on the printing sheet P at the time of performing a printing operation on a single printing sheet is performed in step S35. Accordingly, at the time of transporting the printing sheet P in step S85, as described in step S8 or as described later in step S16, the rear feed unit 32 is in the state shown in FIG. 3C.

When the discharge process on the printing sheet P having been subjected to the printing operation is ended by the processes of steps S31 to S34, the position of the leading end edge of the subsequent printing sheet P is substantially equal to the temporary stop position D1. Thereafter, the process instructing section 62 performs the feed process shown in FIG. 6 again. That is, the process instructing section 62 first judges in step S1 that this feed process is performed on the second or subsequent printing sheet P in the continuous print process and judges whether a predetermined inter-page distance is secured between the trailing end edge of the printing sheet P having been subjected to the printing operation and the leading end edge of the subsequent printing sheet P (step S11). For example, the process instructing section 62 performs the judgment of step S11 on the basis of the fact whether the discharge process of steps S33 to S34 has been performed on the printing sheet P having been subjected to the printing operation, or the information such as a size of the printing sheet P or the after-PE-detection PF transport distance included in the printing instruction from the control instructing section 63.

For example, when the process instructing section 62 judges in step S11 that the inter-page distance is not secured between the trailing end edge of the printing sheet P having been subjected to the printing operation and the leading end edge of the subsequent printing sheet P, such as when the discharge process of steps S33 to S34 is performed on the printing sheet P having been subjected to the printing operation, the process instructing section 62 instructs only the PF motor controller 58 to actuate only the PF motor 14 so as to transport only the printing sheet P having been subjected to the printing operation by using the predetermined inter-page distance as the target intermittent transport distance (step S12).

In step S12, after the inter-page distance is secured between the printing sheet P having been subjected to the printing operation and the subsequent printing sheet P, or when the process instructing section 62 judges in step S11 that the inter-page distance is secured between the printing sheet P having been subjected to the printing operation and the subsequent printing sheet P, the process instructing section 62 judges whether an instruction to print a next page is given (stop S13). For example, the process instructing section 62 performs the judgment of step S13 on the basis of the information such as the number of printing sheets to be subjected to the printing operation, included in the printing instruction from the control instructing section 63.

When the process instructing section 62 judges in step S13 that an instruction to print a next page is given (that is, that the subsequent printing sheet P is not the n-th printing sheet P), as shown in FIG. 5C, the ASF motor controller 59 actuates the ASF motor 31 and the PF motor controller 58 actuates the PF motor 14, in accordance with the instruction from the process instructing section 62 so that the leading end edge of the subsequent printing sheet P stops at the position substantially equal to the print start position D3 (step S14). The synchronization control is performed in step S14. When the PF motor 14 and the ASF motor 31 are deactuated in step S14, the feed process on the printing sheet P is ended and the paper transport process shown in FIG. 1 is performed. Specifically, the process of step S22 is performed.

On the other hand, when the process instructing section 62 judges in step S13 that an instruction to print a next page is not given (that is, that the subsequent printing sheet P is the n-th printing sheet P as the final page), as shown in FIG. 5D, the ASF motor controller 59 actuates the ASF motor 31 and the PF motor controller 58 actuates the PF motor 14, in accordance with the instruction from the process instructing section 62, so that the leading end edge of the subsequent printing sheet P stops at the position substantially equal to the feed standby position D2 (step S15). The synchronization control is performed in step S15. When the leading end edge of the subsequent printing sheet P stops at the position substantially equal to the feed standby position D2, the sub motor controller 60 actuates the sub motor 39 in accordance with the process instructing section 62 (step S16). Specifically, the sub motor controller 60 actuates the sub motor 39 to change the rear feed unit 32 from the state shown in FIG. 3B to the state shown in FIG. 3C.

In step S15, the leading end edge of the printing sheet P is aligned with the feed standby position D2 on the basis of the after-PE-detection ASF transport distance. That is, in step S16, the sub motor 39 is controlled to drive the rear feed unit 32 on the basis of the after-PE-detection ASF transport distance calculated by the PE sensor 9.

Thereafter, the process instructing section 62 instructs only the PF motor controller 58 to actuate only the PF motor 14 (step S17) so that the leading end edge of the subsequent printing sheet P stops at the position substantially equal to the print start position D3. When the PF motor 14 is deactuated in step S17, the feed process on the printing sheet P is ended and the paper transport process shown in FIG. 7 is performed. Specifically, the process of step S29 is performed.

When it is judged in step S14 or S15 that the PE sensor 9 detects the leading end edge of the printing sheet P, the detection value calculator 56 generates the detection value of the after-PE-detection PF transport distance on the basis of the detection signal of the PF encoder 47, generates the detection value of the after-PE-detection ASF transport distance on the basis of the detection signal of the ASE encoder 48, and updates the information on the after-PE-detection PF transport distance and the information on the after-PE-detection ASF transport distance stored in the memory 57.

In this embodiment in the feed process on the printing sheet P other than steps S9 and B17, the transport distance of the printing sheet P is calculated on the basis of the after-PE-detection ASF transport distance generated from the detection signal of the ASF encoder 48. That is, in the feed process on the printing sheet P other than steps S9 and S17, the transport control of the printing sheet P is performed on the basis of the transport distance of the printing sheet P by the rear feed roller 27. On the other hand, in the process of step S9, the process of step S17, the paper transport process, and the discharge process, the transport distance of the printing sheet P is calculated on the basis of the after-PE-detection PF transport distance generated from the detection signal of the PF encoder 47. That is, in the process of step S9, the process of step S17, the paper transport process, and the discharge process, the transport control of the printing sheet P is performed on the basis of the transport distance of the printing sheet P by the PF driving roller 4

In this embodiment, steps S3, S6, S7, S14, and S15 of the feed process, steps S24 and S26 of the paper transport process, and step S34 of the discharge process include the transport step of making the PF driving roller 4 and the rear feed roller 27 rotate at substantially the same peripheral speed and transporting the printing sheet P fed from the rear feed unit 32 in cooperation of the PF driving roller 4 with the rear feed roller 27. In this embodiment, steps Se and S16 of the feed process include the feed unit driving step of controlling the sub motor 39 to drive the rear feed unit 32 so that the rear feed unit 32 cannot teed the (n+1-th printing sheet P exceeding the designated number of printing sheets.

### Advantages of Embodiment

As described above, in predetermined process steps of the continuous print process in the draft print mode of this embodiment, the numbers of revolutions of the PF motor 14 and the ASF motor 31 are controlled so that the peripheral speed of the rear feed roller 27 transporting the printing sheet P in cooperation with the PD driving roller 4 is substantially equal to the peripheral speed of the PF driving roller 4. Accordingly, the PF driving roller 4 and the rear feed roller 27 can be made to rotate in synchronization with each other and the operation of feeding the subsequent printing sheet P can be performed without hindering the discharging operation or the printing operation on the previous printing sheet P. That is, since the printing operation or the discharging operation and the feeding operation can be performed as a series of operations, it is possible to further enhance the throughput in the continuous print process. Since the PF driving roller 4 and the rear feed roller 27 can be made to rotate, it is possible to properly transport the printing sheet P between the PF driving roller 4 and the rear feed roller 27. As a result, it is possible to suppress sounds, which may be generated at the time of transporting the printing sheet, from being generated in the printing sheet P due to a variation in tension applied to the printing sheet P.

in this embodiment, when the designated number of printing sheets is n, the sub motor 39 is controlled to drive the rear teed unit 32 in steps S0 and S16 so that the rear feed unit 32 cannot feed the (n+1)-th printing sheet P not to be subjected to the printing operation. Accordingly, even when the PF driving roller 4 and the rear feed roller 27 are made to rotate in synchronization with each other, it is possible to prevent the printing sheet P not to be subjected to the printing operation from being fed to the printing area. As a result, it is possible to omit unnecessary operations such as the discharging operation of the printing sheet P not to be fed to the printing area.

In this embodiment, in steps S8 and S16, the sub motor 39 is actuated to move the feed hopper 26 in the direction in which the printing sheet P gets away from the rear feed roller 27, to move the retard roller 28 in the direction in which it gets away from the rear feed roller 27, and to drive the paper returning lever 29 in the direction in which the printing sheet P is returned to the feed hopper 26. Accordingly, it is possible to reliably prevent the printing sheet not to be subjected to the printing operation from being fed to the printing area.

In this embodiment, the sub motor 39 is controlled to drive the rear feed unit 32 on the basis of the after-PE-detection ASF transport distance which is the transport distance of the printing sheet P by the rear feed roller 27 after the detection of the PE sensor 9. Accordingly, it is possible to precisely grasp the positions of the leading end edge and the trailing end edge of the printing sheet P on which the printing operation starts to be performed. Therefore, in the configuration of this embodiment in which the PF driving roller 4 and the rear feed roller 27 are made to rotate in synchronization with each other, it is possible to precisely grasp the information on the leading end edge of the (n+1)-th printing sheet P not to be subjected to the printing operation on the basis of the information on the position of the trailing end edge of the final printing sheet P (that is, the n-th printing sheet) of the designated number of printing sheets. As a result, by actuating the sub motor 39 at a proper timing, it is possible to further reliably prevent the printing sheet P not to be subjected to the printing operation from being fed to the printing area.

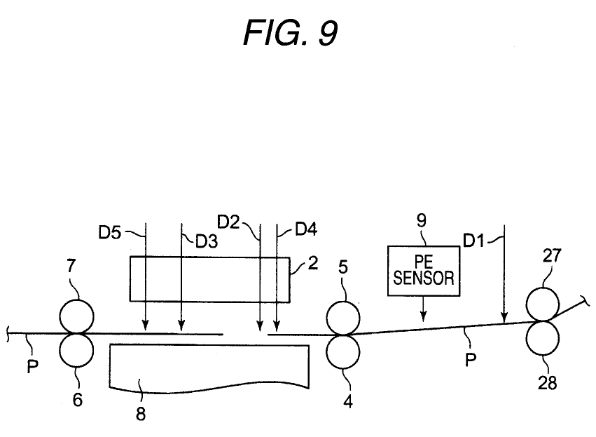

In this embodiment, in steps S7 and S15, when the leading end edge of the n-th printing sheet P reaches the feed standby position D2, the PD motor 14 and the ASF motor 31 are deactuated. In steps S8 and S16, the sub motor 39 is controlled to drive the rear feed unit 32 in the state shown in FIG. 3C. Accordingly, it is possible to control the sub motor 39 on the basis of the fact that the leading end edge of the n-th printing sheet P reaches the feed standby position D2 and the PF motor 14 and the ASF motor 31 are deactuated. Accordingly, it is possible to simplify the control of sub motor 39. When the processes of steps S7, S15, S18, and S16 are not performed, the subsequent (n+1)-th printing sheet P is fed to the printing area by the feed process, as shown in FIG. 9, at the time of performing the printing operation on only a portion of the trailing end edge of the printing sheet P. However, such a problem can be solved by employing the configuration of this embodiment.

In this embodiment, the sub rotor 39 is not actuated until the leading end edge of the n-th printing sheet P reaches the feed standby position D2 after the printing operation is started on the first printing sheet P in the continuous print process. Accordingly, since it is not necessary to actuate the sub motor 39 from the start of the printing operation on the first printing sheet P to the printing operation on the (n−1)-th printing sheet, it is possible to further enhance the throughput in the continuous print process.

### Other Embodiments

In steps S7 and S15 of the above-mentioned embodiment, when the leading end edge of the n-th printing sheet 2 reaches the feed standby position D2, the PF motor 14 and the ASF motor 31 are deactuated, and the rear feed unit 32 is driven to the state shown in FIG. 3C in steps S8 and S16. However, for example, the position of the trailing end edge of the n-th printing sheet P which is the final printing sheet may be grasped on the basis of the after-PE-detection PF transport distance, the rear feed unit 32 may be driven to the state shown in FIG. 3C before the trailing end edge of the n-th printing sheet P leaves from (is pulled out of) the feed hopper 26, or before the trailing end edge of the n-th printing sheet P passes the contact position between the rear feed roller 27 and the retard roller 2S, or when the leading end edge of the (n+1)-th printing sheet P is located in the range in which the paper returning lever 29 can come in contact with the leading end edge of the printing sheet P and can return the printing sheet to the (n+1)-th printing sheet P to the feed hopper 26. That is, the rear feed unit 32 may be driven to the state shown in FIG. 3C so that the rear feed unit 32 cannot feed the (n+1)-th printing sheet P.

In steps S8 and S16 of the feed process of the above-mentioned embodiments the rear feed unit 32 is driven to the state shown in FIG. 3C. However, the rear feed unit 32 may be driven to the state shown in FIG. 3C so that the rear feed unit 32 cannot feed the (n+1)-th printing sheet P during the discharge process or the paper transport process.

In step S8 and S16 of the above-mentioned embodiment, the sub motor 39 is actuated to drive the feed hopper 26, the retard roller 28, and the paper returning lever 29. However, the driving mechanism 30 may be configured to independently drive the feed hopper 26, the retard roller 28, and the paper returning lever 29 and at least one of the feed hopper 26, the retard roller 28, and the paper returning lever 29 in steps S8 and S16. In this case, it is possible to prevent the (n+1-th printing sheet P not to be subjected to the printing operation from being fed to the printing area.

In steps S7 and S15 of the above-mentioned embodiment, when the leading end edge of the n-th printing sheet P reaches the feed standby position D2, the PT motor 14 and the ASF motor 31 are deactuated. In steps S7 and S15, the reference position which the leading end edge of the n-th printing sheet P reaches is not limited to the feed standby position 12, but the reference position may be set on the upstream side of the feed standby position D2 or on the downstream side of the feed standby position D2. For example, the reference position may be the upstream nozzle position D4.

In the above-mentioned embodiments the sub motor 39 is controlled to drive the rear feed unit 32 on the basis of the ASF transport distance after the PE detection of the PE sensor 9. The sub motor 39 may be controlled to drive the rear feed unit 32 on the basis of a distance by which the printing sheet P is transported by the rear feed roller 27 after the PW detection of a PW sensor attached to the carriage 3.

In the above-mentioned embodiment, the transport control method of the printing sheet P in the printer 1 has been described with reference to the case where the printing sheet P is fed into the printer 1 from the rear side. However, the transport control of the printing sheet P according to the embodiment may be applied to a case where the printing sheet P is fed into the printer 1 from the front side. The configuration according to this embodiment may be applied to various apparatuses such as laser printers having a feed mechanism, in addition to the ink jet printers.

What is claimed is:

1. A method of controlling a printer including a feeder on which plural printing mediums are set, a first roller operable to pickup the plural printing mediums one by one from the feeder, and a second roller operable to transport the plural printing mediums together with the first roller, the plural printing mediums include at least one first medium and a second medium subsequent to the first medium, the method comprising:
controlling the first and second rollers so that a peripheral speed of the first roller and a peripheral speed of the second roller are equal to each other; and
controlling the feeder so that the first roller cannot pickup the second medium from the feeder when receiving the printing instruction for performing the printing operation to only the first medium.

2. The method according to claim 1, wherein
the feeder includes a hopper on which the printing mediums are set and which can be moved in a first direction in which the printing mediums are urged toward the first roller so that the first roller can pickup the printing mediums and in a second direction in which the printing mediums are separated from the first roller, and
in the controlling process of the feeder, the hopper is moved in the second direction before a trailing end edge of the first medium leaves front the hopper.

3. The method according to claim 1, wherein
the feeder includes a third roller which can come in contact with the first roller at a contact position to transport the printing mediums along with the first roller and which can be moved in a first direction as to approach the first roller and in a second direction as to be separated from the first roller, and
in the controlling process of the feeder, the third roller is moved in the second direction before a trailing end edge of the first medium passes the contact position.

4. The method according to claim 1, wherein
the feeder includes a hopper on which the printing mediums are set and a returning lever which can come in contact with leading end edges of the printing mediums within a predetermined range and can be moved in a direction to return the printing mediums to the hopper, and
in the controlling process of the feeder, when the leading end edge of the second medium is located within the predetermined range, the returning lever is moved in the direction.

5. The method according to claim 1, further comprising:
detecting the printing mediums between the first roller and the second roller, wherein
in the controlling process of the feeder, the feeder is controlled based on the detection result.

6. The method according to claim 1, wherein
when a leading end edge of the first medium reaches a predetermined reference position, the first and second rollers are controlled to stop, and the feeder is controlled.

7. The method according to claim 6, wherein
the first medium includes at least two mediums, first one of the at least two mediums is initially transported from the feeder among the first medium and second one of the at least two mediums is finally transported from the feeder among the first medium, and
after the printing operation to the first one is started, when the leading end edge of the second one reaches the predetermined reference position, initial control for the feeder is performed.

8. A printer comprising:
a feeder, on which plural printing mediums are set;
a first roller, operable to pickup the plural printing mediums one by one from the feeder;
a second roller, operable to transport the plural printing mediums together with the first roller; and
a controller, operable to control the feeder, the first roller and the second roller, and operable to receive a printing instruction for performing a printing operation to each of the plural printing mediums, wherein
the controller controls the first and second rollers so that a peripheral speed of the first roller and a peripheral speed of the second roller are equal to each other,
the plural printing mediums include at least one first medium and a second medium subsequent to the first medium, and
when the controller receives the printing instruction for performing the printing operation to only the first medium, the controller controls the feeder so that the first roller cannot pickup the second medium from the feeder.
